(19) United States
(12) Patent Application Publication
(10) Pub. No.: US 2015/0068465 A1
(43) Pub. Date: Mar. 12, 2015

(54) Litter Box Fence

(71) Applicant: Diane LaPierre, Plant City, FL (US)

(72) Inventor: Diane LaPierre, Plant City, FL (US)

(21) Appl. No.: 14/020,869

(22) Filed: Sep. 8, 2013

(51) Int. Cl. A01K 1/01

(52) U.S. Cl. CPC A01K 1/0107
USPC 119/165

(57) ABSTRACT

An apparatus placed on the floor, in front of a litter box so when a cat exit a litter box, the litter material dislodging under its paws remains in the enclosed apparatus preventing that litter from scattering all over the floors. The apparatus can be easily and conveniently removed to sweep or vacuum the litter material on the floor. If the cat doesn't object, a puppy training pad, carpet or other similar object can be placed on the floor, inside the apparatus, to help collect the litter. The collected litter material can be recycled into the litter box or discarded.

### CROSS-REFERENCE TO RELATED APPLICATION

This application claims the benefits of provisional patent application Ser. No. 61/698,685, filed Sep. 9, 2012 by the present inventor.

### TECHNICAL FIELD OF THE INVENTION

The present invention relates to a litter box barrier, particularly an apparatus consisting of 3 sidewalls, placed on the floor in front of a litter box to hold the litter dislodging under a cats' paws when exiting a litter box.

### BACKGROUND OF THE INVENTION

Cats commonly use litter boxes, and some of the litter material inside the box always attaches to their paws. Upon exiting the litter box, that litter material dislodge from their paws and scatters all over the surrounding areas.

Mats, carpets or puppy training pads are often use in front of a litter box to collect that discarded litter from the pet's paws although many cats object to walk or step on anything placed in front of a litter box.

Another problem associated with the scattering of the litter material is the particles which are gritty can be irritating to the bare feet when stepped on by humans and are also unsanitary.

Therefore, there is a need for an apparatus to hold that litter material that cats will not object too, to prevent such litter to scatter all over the floors.

### BRIEF SUMMARY OF THE INVENTION

An apparatus placed in front of a litter box to hold cat litter dislodging from cat's paws upon exiting a litter box. The litter box fence is made of plastic material and can be completely folded.

### BRIEF DESCRIPTION OF THE DRAWINGS

FIG. 1 is a view of the invention setup in front of a litter box;

FIG. 2 is a perspective view of the litter box fence by itself;

FIG. 3 is a view of the top pin that will interlock with the bottom pin;

FIG. 4 is a view of the top and bottom pins;

FIG. 5 is a view of the spacing between the pins and sidewalls to allow rotating;

FIG. 6 is a view of the cat litter barrier folded with measurements;

### DETAILED DESCRIPTION OF THE INVENTION

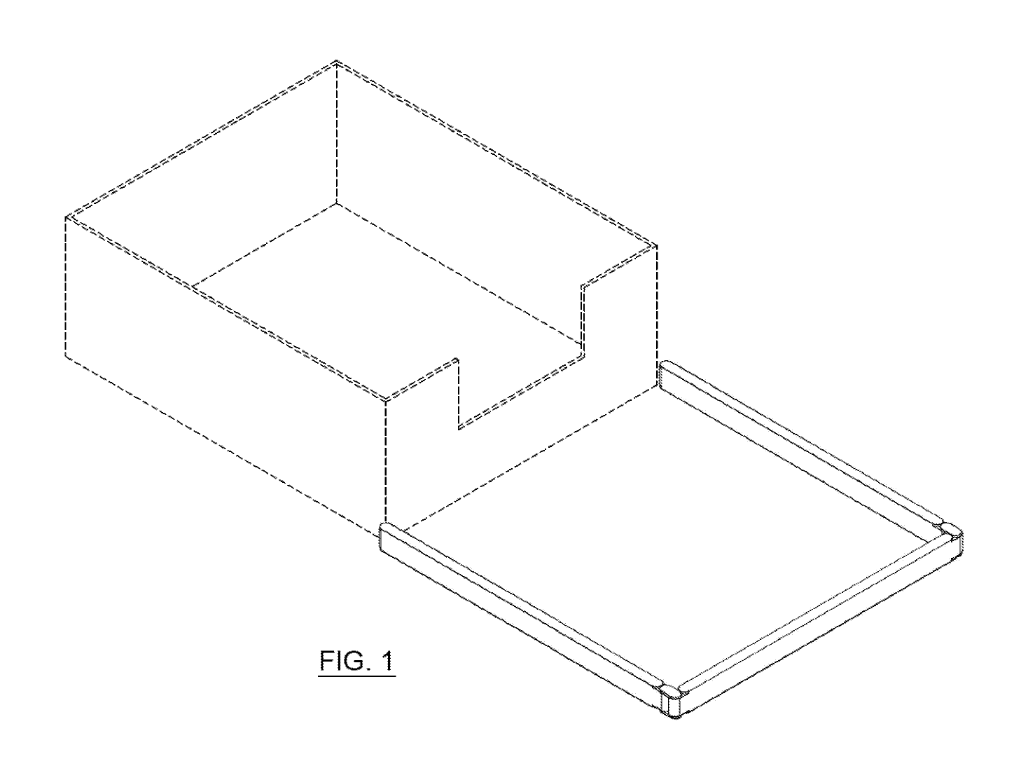

FIG. 1 shows the litter box fence placed in front of a litter box. The fence does not attach to the litter box although one can use strips of VELCRO™ or any suitable material to attach both ends of the sidewalls to the litter box to prevent it from moving. The reason for not including any type of attachment is for the ease of removing the fence to clean the discarded litter on the floor, inside the fence. You just remove the litter box fence, sweep or vacuum the litter and place the apparatus back in its original position.

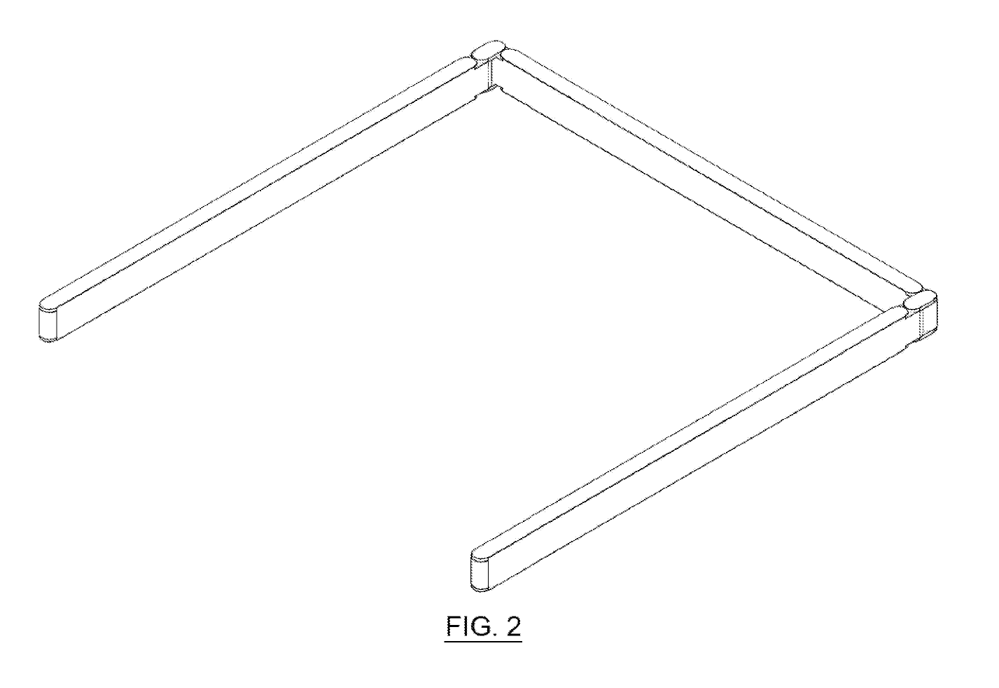

In FIG. 2, the apparatus is shown by itself. It is comprised of 3 sidewalls interconnected to a pivoting system consisting of two pins that interlocks into each other. The pivoting system allows the sidewalls to rotate 360 degree.

The litter box fence is built of rigid plastic due to the relative ease of molding it, low cost, light weight and ease of maintenance. Although any suitable materials such as, but not limited to thermoplastics, metals, woods and fiberglass can also be used.

The middle is completely open showing the floor.

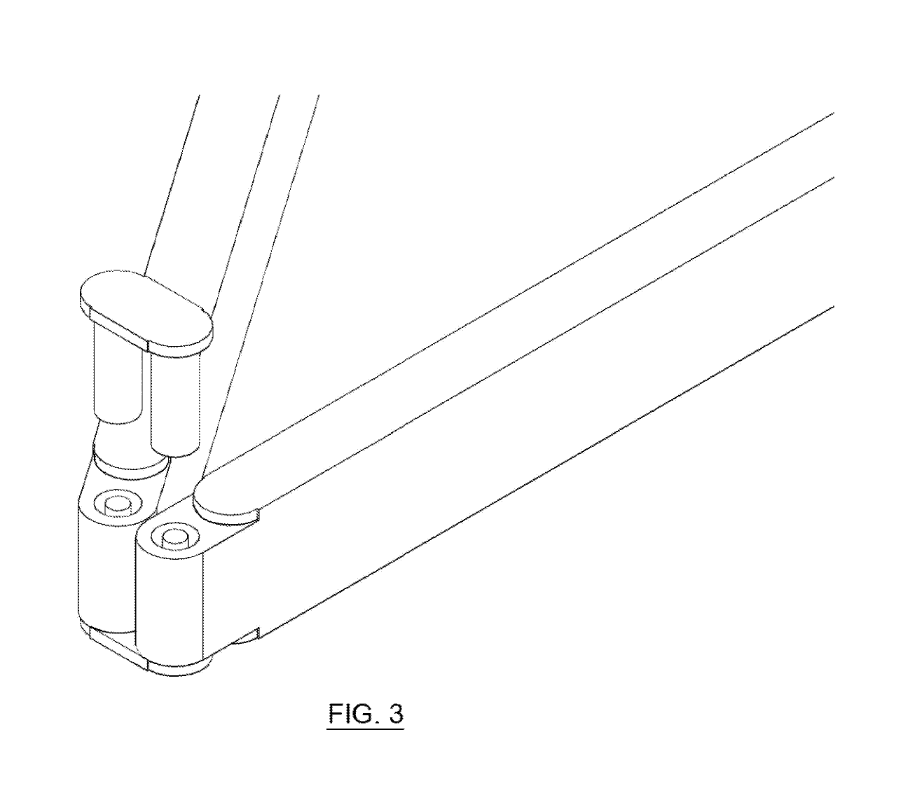

FIG. 3 shows the pivoting system. It consists of a top pin and a bottom pin made of the same material as the sidewalls. Those two pins snap into each other creating a locking connection. The pivoting connections allow the 3 sidewalls to rotate 360 degrees. This offers flexibility so the width of the two sidewalls can extend in or out to accommodate smaller or larger type of litter boxes or any type of cat litter receptacle used by the owner.

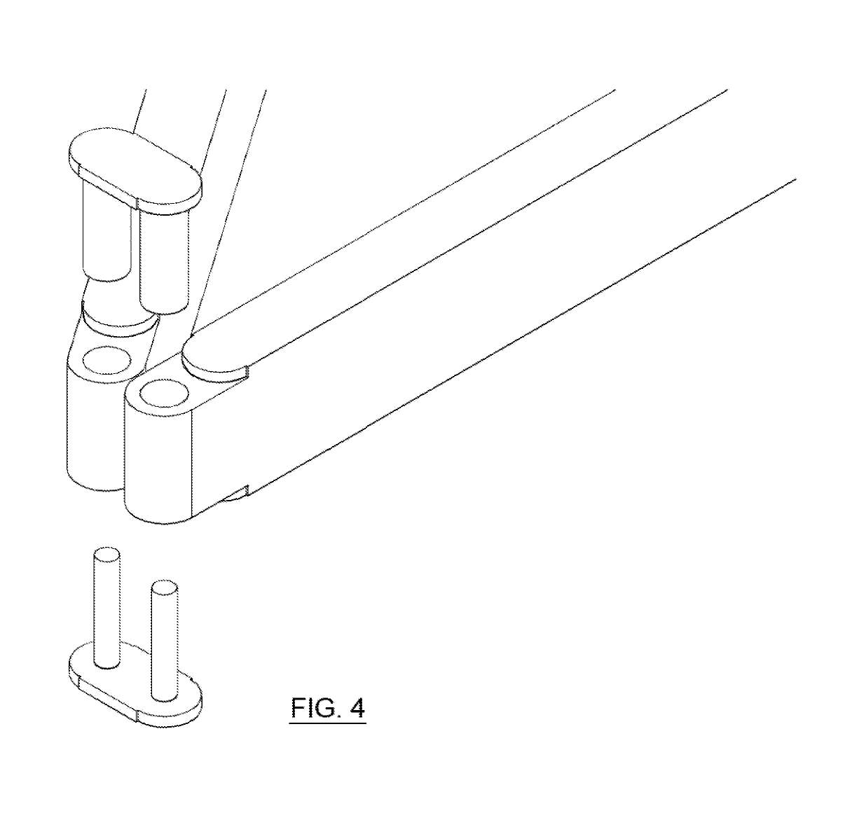

FIG. 4 shows the top and bottom pins. The bottom pin is smaller so it can interconnect into the top pin.

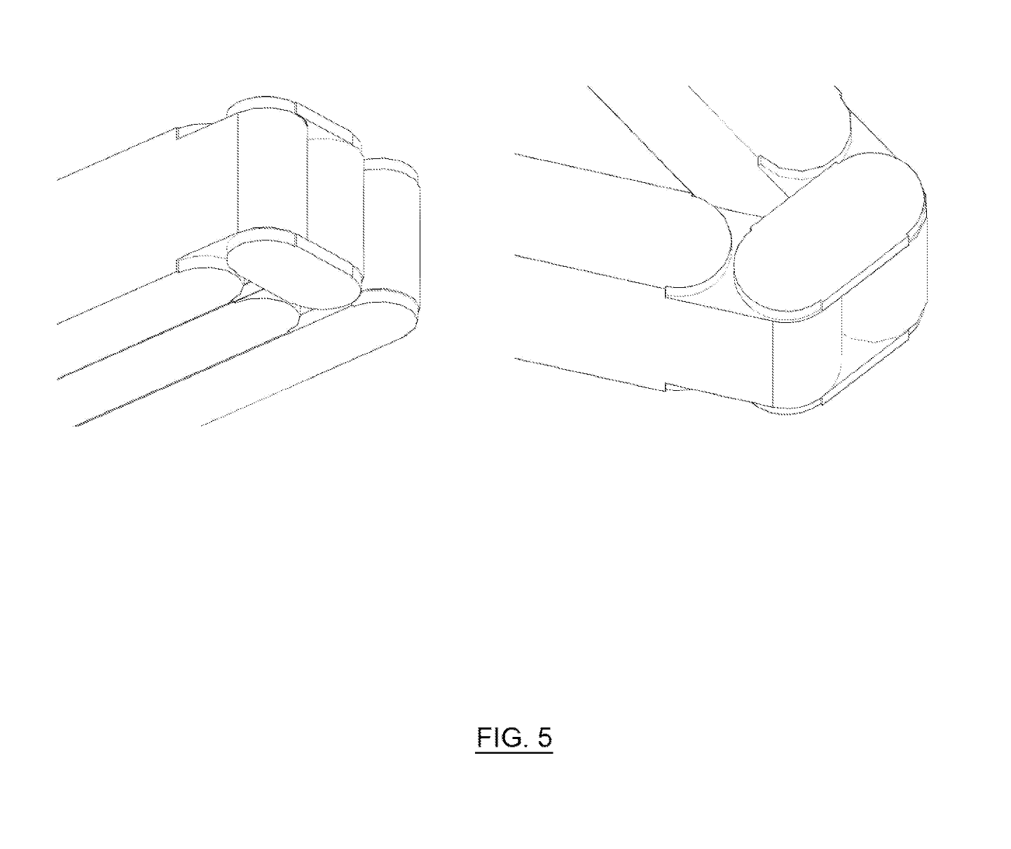

FIG. 5 shows the small spacing between the sidewalls and pivots allowing the sidewalls to rotate freely.

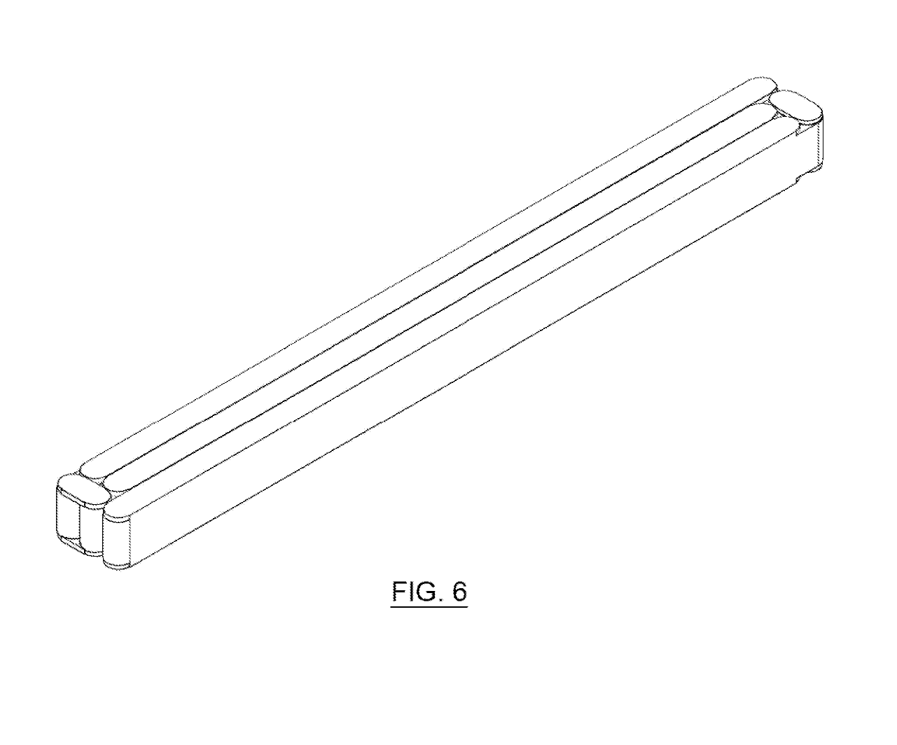

FIG. 6 shows the cat litter barrier completely closed with measurements. The sidewalls have a top and sides measurement of 1½ inches and the sidewalls are 24 inches minimum in length. The length of the side sidewalls has to be long enough to accommodate large cats because when a cat exits the litter box, all four paws have to touch the floor inside the fence. If it does not happen, the litter from under its paws will end outside the apparatus, defeating the purpose of retaining the litter. The litter box fence can easily be fold for transportation or for storage.

The above invention description is considered illustrative only of the principles of the invention. Furthermore, modifications can readily be made by one of ordinary skill to the exact process above. Accordingly, the above description and drawings should not be considered as limiting the extent of this invention as defined by the claim below.

1. I claim a litter box fence consisting of three interconnected sidewalls to retain litter dislodging under a pets' paw upon exiting the litter box.
